(19) United States
(12) Patent Application Publication
(10) Pub. No.: US 2025/0328014 A1
(43) Pub. Date: Oct. 23, 2025

(54) Eyeglass Translation System

(71) Applicant: Bienvenido Daniel Castro, Hawthorne, CA (US)

(72) Inventor: Bienvenido Daniel Castro, Hawthorne, CA (US)

(21) Appl. No.: 18/640,718

(22) Filed: Apr. 19, 2024

(51) Int. Cl. G02B 27/01; G02C 11/00; G06F 40/40

(52) U.S. Cl. CPC G02B 27/0172; G02C 11/10; G06F 40/40

(57) ABSTRACT

An eyeglass translation system includes a wearable frame, an audiovisual input assembly, a microprocessor, and an audiovisual output assembly. The wearable frame includes rims, a pair of temples, and a pair of lenses in the rims. The audiovisual input assembly is positioned in the frame and is designed to receive spoken and written words. The microprocessor is positioned in the frame and is operatively connected to the audiovisual input assembly to receive input words from the audiovisual input assembly and translate input words into a selected language. The audiovisual output assembly is positioned in the frame and operatively connected to the microprocessor to produce visual text or audio of translated input words received from the microprocessor. The eyeglass translation system can detect spoken or written words, translate the words into a selected language, and then provide audio or visual images of the translated words.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to smart glasses and more particularly pertains to a new eyeglass translation system to provide users with a wearable translation system that can detect spoken or written words, translate the words into a selected language, and then provide audio or visual images of the translated words.

### (2) Description of Related Art including information disclosed under 37 CFR 1.97 and 1.98.

The prior art relates to smart glasses. The prior art, as best understood, does not disclose an eyeglass translation system generally comprising a wearable frame, an audiovisual input assembly, a microprocessor, and an audiovisual output assembly, that can detect spoken or written words, translate the words into a selected language, and then provide audio or visual images of the translated words.

### (h) BRIEF SUMMARY OF THE INVENTION

An embodiment of the disclosure meets the needs presented above in an eyeglass translation system generally comprising a wearable frame, an audiovisual input assembly, a microprocessor, and an audiovisual output assembly. The wearable frame includes rims, a pair of temples, and a pair of lenses in the rims. The audiovisual input assembly is positioned in the frame and is designed to receive spoken and written words. The microprocessor is positioned in the frame and is operatively connected to the audiovisual input assembly to receive input words from the audiovisual input assembly and translate input words into a selected language. The audiovisual output assembly is positioned in the frame and operatively connected to the microprocessor to produce visual text or audio of translated input words received from the microprocessor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an eyeglass translation system according to an embodiment of the disclosure.

FIG. 2 is a front view of an embodiment of the disclosure.

FIG. 3 is a side view of an embodiment of the disclosure.

FIG. 4 is a rear perspective view of an embodiment of the disclosure.

FIG. 5 is a side view of an embodiment of the disclosure in use.

FIG. 6 is a front perspective view of an embodiment of the disclosure in use.

FIG. 7 is a perspective view of an embodiment of the disclosure in storage.

FIG. 8 is a block diagram of an embodiment of the disclosure.

### (j) DETAILED DESCRIPTION OF THE INVENTION

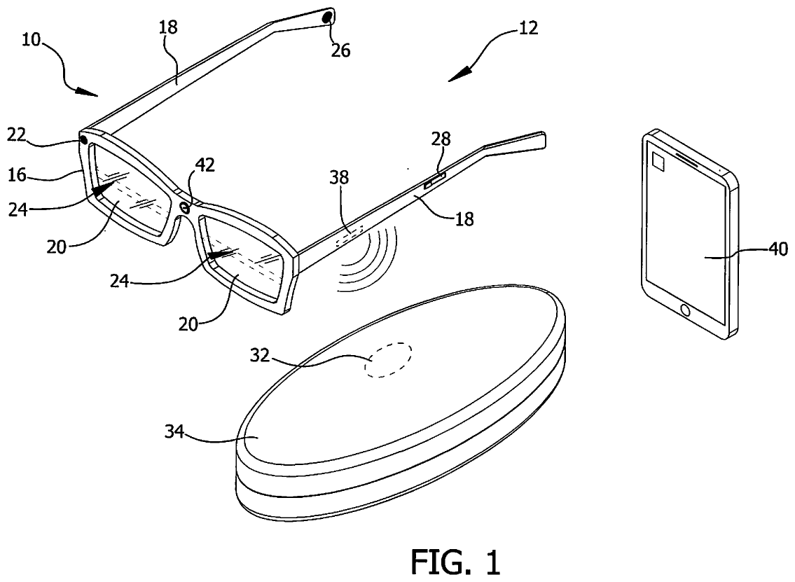

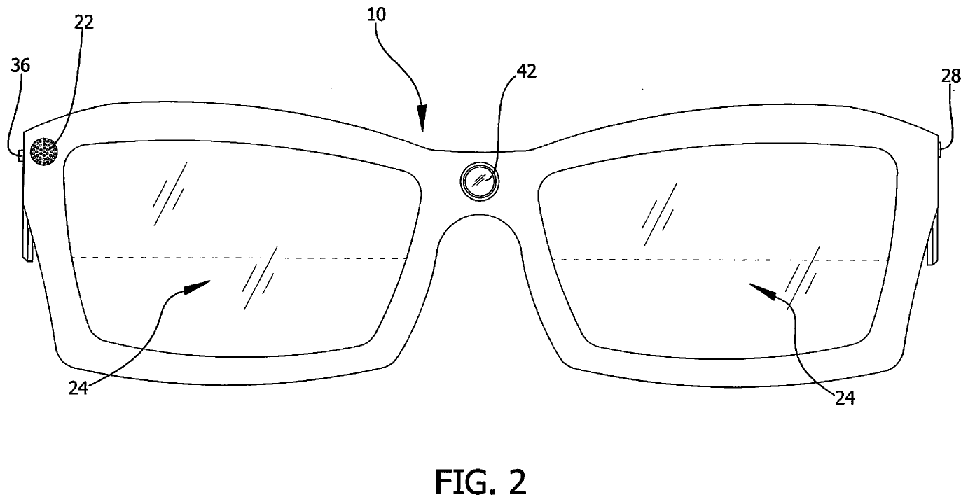

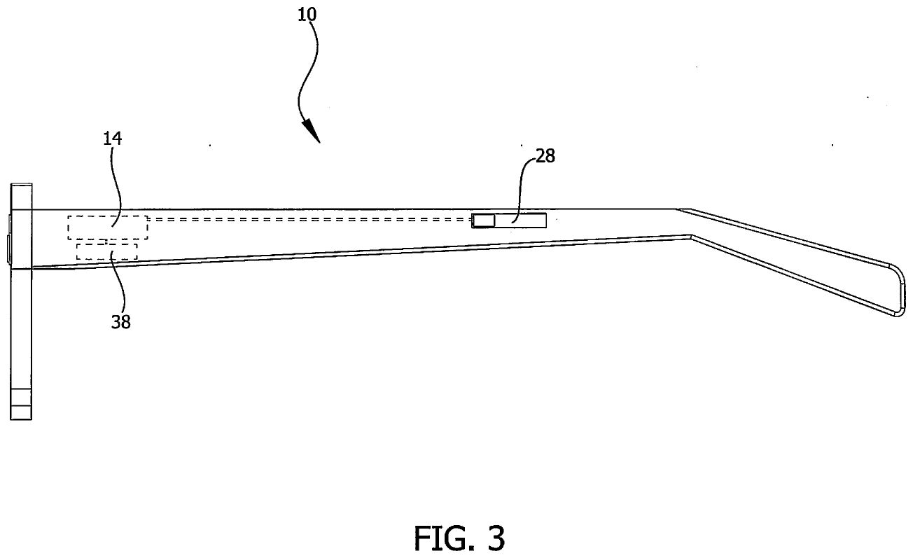

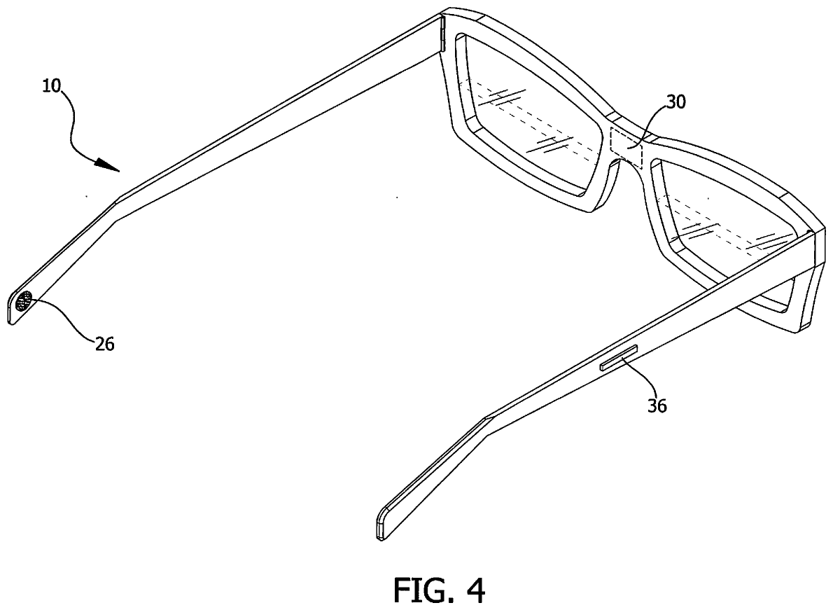

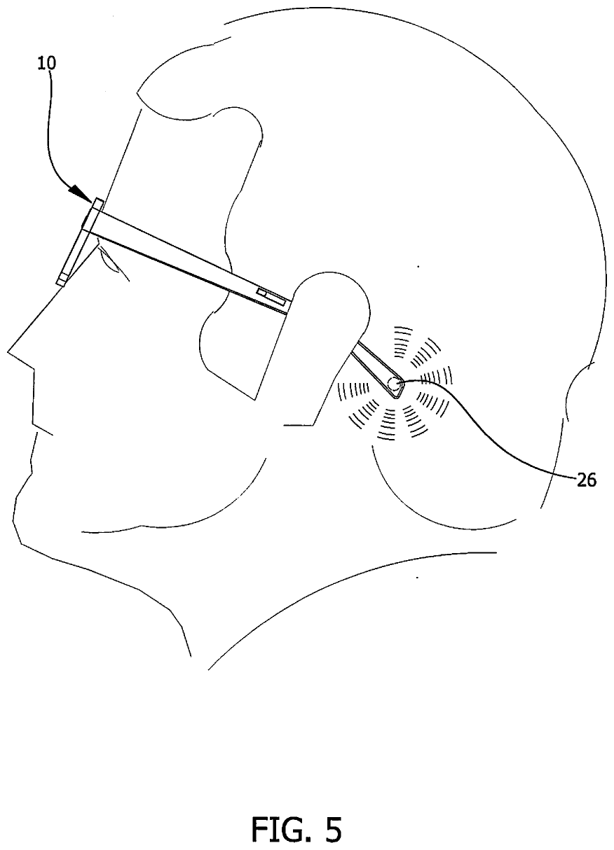

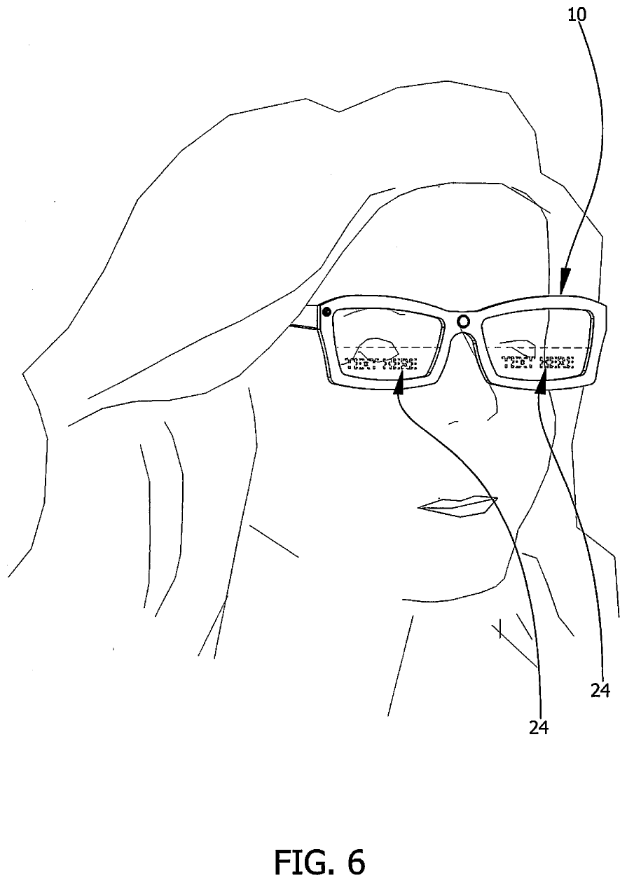

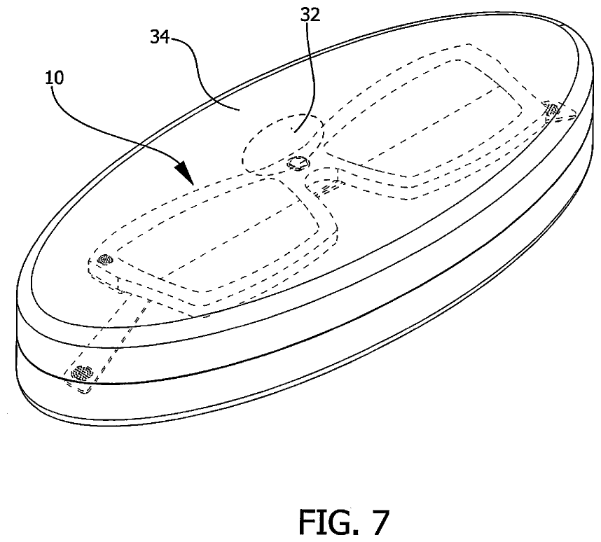

With reference now to the drawings, and in particular to FIGS. 1 through 8 thereof, a new eyeglass translation system embodying the principles and concepts of an embodiment of the disclosure and generally designated by the reference numeral 10 will be described.

As best illustrated in FIGS. 1 through 8, the eyeglass translation system 10 generally comprises a wearable frame 12, an audiovisual input assembly, a microprocessor 14, and an audiovisual output assembly. The wearable frame 12 includes rims 16, a pair of temples 18, and a pair of lenses 20 in the rims 16. The audiovisual input assembly is positioned in the frame 12 and is designed to receive spoken and written words. The audiovisual input assembly includes a microphone 22 to receive audio input and a camera 42 to receive visual input. Both the camera 42 and the microphone 22 can be positioned in the front face of the rims 16. The microprocessor 14 is positioned in the frame 12 and is operatively connected to the audiovisual input assembly to receive input words from the audiovisual input assembly. The microprocessor 14 has a computer application to translate the input words into a selected language. The audiovisual output assembly is positioned in the frame 12 and operatively connected to the microprocessor 14 to produce visual text or audio of translated input words received from the microprocessor 14. The audiovisual output assembly includes an image system 24 designed to display visual images of translated input words on the lenses 20. The audiovisual output assembly also includes a speaker assembly to emit audio of translated input words. In one embodiment, the speaker assembly includes a speaker 26 positioned on a distal portion of one of the pair of temples 18, such that the speaker 26 is close to the user's ear. In another possible embodiment, the speaker assembly includes a pair of the speakers 26 positioned on each of the pair of temples 18.

The eyeglass translation system 10 also includes a switch 28 positioned on the frame 12 and operatively connected to the microprocessor 14 to switch between audio and visual output. The switch 28 sends a signal to the microprocessor 14 to selectively activate the audio output or the visual output, although in another possible embodiment the switch 28 could permit a selection of both audio and visual output. In addition, a rechargeable power source 30 is positioned in the frame 12. The rechargeable power source 30 is wirelessly connectable to a wireless charger 32. FIG. 1 shows a storage container 34 for storing the eyeglass translation system 10. The storage container 34 includes wireless charger 32 to charge the power source 30 while in storage. A power switch 36 is positioned in the frame 12 and designed to turn the microprocessor 14 on and off to activate and deactivate the eyeglass translation system 10.

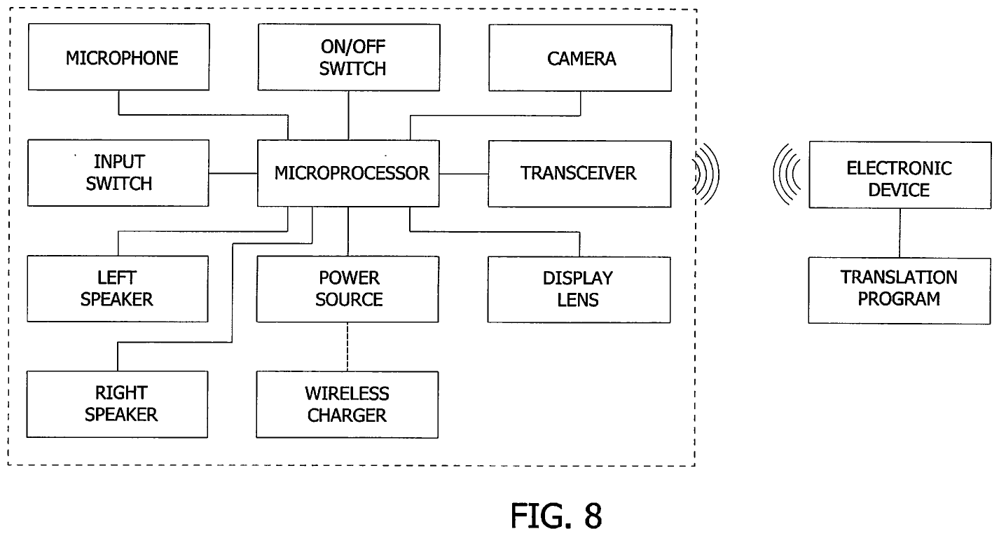

In one possible embodiment, as shown in the block diagram in FIG. 8, the eyeglass translation system 10 includes a transceiver 38 disposed in the frame 12 and operatively connected to the microprocessor 14. Instead of the translation program being stored in the microprocessor 14, the translation program is stored on a wireless electronic device 40, such as a computer or smartphone. The transceiver 38 is wirelessly connectable to the wireless electronic device 40 to transmit input words to the translation program and receive translated input words from the translation program. The translation program could include multiple languages that are selectable on the translation program so the user can use the eyeglass translation system 10 for multiple languages.

To use the eyeglass translation system 10, the user wears the frame 12. When the user needs translation of words, the camera 42 obtains images of printed text and the microphone 22 obtains audio of spoken words. The translation program, whether stored on the microprocessor 14 or a wireless electronic device 40, translates the words into a selected language that the user understands. The image system 24 displays visual text of the translated words on the lenses 20 to be read by the user, and the speaker 26 outputs audio of the translated words to be heard by the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An eyeglass translation system comprising:
a wearable frame comprising rims, a pair of temples, and a pair of lenses in said rims;
an audiovisual input assembly disposed in said frame and configured to receive spoken and written words;
a microprocessor disposed in said frame and operatively connected to said audiovisual input assembly to receive input words from said audiovisual input assembly and translate input words into a selected language; and
an audiovisual output assembly disposed in said frame and operatively connected to said microprocessor to produce visual text or audio of translated input words received from said microprocessor;
said audiovisual output assembly comprises a switch disposed on one of said temples of said frame and operatively connected to said microprocessor to switch between audio and visual output; and
the eyeglass translation system further comprises a power switch disposed in said frame and configured to turn said microprocessor on and off to activate and deactivate the eyeglass translation system.

2. The eyeglass translation system of claim 1, wherein said audiovisual output assembly comprises an image system disposed on said frame and configured to display visual images of translated input words on said lenses.

3. The eyeglass translation system of claim 2, wherein said audiovisual output assembly comprises a speaker assembly to emit audio of translated input words.

4. The eyeglass translation system of claim 3, wherein said speaker assembly comprises a speaker disposed on a distal portion of one of said pair of temples.

5. The eyeglass translation system of claim 4, wherein said speaker assembly comprises a pair of said speakers disposed on each of said pair of temples.

6. (canceled)

7. The eyeglass translation system of claim 1, wherein said audiovisual input assembly comprises a microphone to receive audio input.

8. The eyeglass translation system of claim 7, wherein said audiovisual input assembly comprises a camera to receive visual input.

9. The eyeglass translation system of claim 1, wherein the eyeglass translation system further comprises a rechargeable power source disposed in said frame.

10. The eyeglass translation system of claim 9, wherein said rechargeable power source is wirelessly connectable to a wireless charger.

11. (canceled)

12. An eyeglass translation system comprising:
a wearable frame comprising rims, a pair of temples, and a pair of lenses in said rims;
an audiovisual input assembly disposed in said frame and configured to receive spoken and written words;
a microprocessor disposed in said frame and operatively connected to said audiovisual input assembly to receive input words from said audiovisual input assembly;
a transceiver disposed in said frame and operatively connected to said microprocessor;
a translation program storable on a wireless electronic device, wherein said transceiver is wirelessly connectable to a wireless electronic device having said translation program to transmit input words to said translation program and receive translated input words from said translation program; and
an audiovisual output assembly disposed in said frame and operatively connected to said microprocessor to produce visual text or audio of translated input words received from said microprocessor; and
said audiovisual output assembly comprises a switch disposed on said frame and operatively connected to said microprocessor to switch between audio and visual output.

13. The eyeglass translation system of claim 12, wherein said audiovisual output assembly comprises an image system disposed on said frame and configured to display visual images of translated input words on said lenses.

14. The eyeglass translation system of claim 13, wherein said audiovisual output assembly comprises a speaker assembly to emit audio of translated input words.

15. The eyeglass translation system of claim 14, wherein said speaker assembly comprises a speaker disposed on a distal portion of one of said pair of temples.

16. The eyeglass translation system of claim 15, wherein said speaker assembly comprises a pair of said speakers disposed on each of said pair of temples.

17. (canceled)

18. The eyeglass translation system of claim 12, wherein said audiovisual input assembly comprises a microphone to receive audio input.

19. The eyeglass translation system of claim 18, wherein said audiovisual input assembly comprises a camera to receive visual input.

20. An eyeglass translation system comprising:
a wearable frame comprising rims, a pair of temples, and a pair of lenses in said rims;
an audiovisual input assembly disposed in said frame and configured to receive spoken and written words, wherein said audiovisual input assembly comprises:
a microphone to receive audio input, a camera to receive visual input;
a microprocessor disposed in said frame and operatively connected to said audiovisual input assembly to receive input words from said audiovisual input assembly and translate input words into a selected language;
an audiovisual output assembly disposed in said frame and operatively connected to said microprocessor to produce visual text or audio of translated input words received from said microprocessor, wherein said audiovisual output assembly comprises:
an image system configured to display visual images of translated input words on said lenses,
a speaker assembly to emit audio of translated input words, said speaker assembly comprises a speaker disposed on a distal portion of one of said pair of temples, said speaker assembly comprises a pair of said speakers disposed on each of said pair of temples,
a switch disposed on one of said temples of said frame and operatively connected to said microprocessor to switch between audio and visual output;
a rechargeable power source disposed in said frame, said rechargeable power source is wirelessly connectable to a wireless charger; and
a power switch disposed in said frame and configured to turn said microprocessor on and off to activate and deactivate the eyeglass translation system.

21. The eyeglass translation system of claim 20, further comprising a storage container for storing said wearable frame, wherein said storage container includes a wireless charger to charge said rechargeable power source while in storage.

22. The eyeglass translation system of claim 10, further comprising a storage container for storing said wearable frame, wherein said storage container includes a wireless charger to charge said rechargeable power source while in storage.

23. The eyeglass translation system of claim 12, further comprising:
a rechargeable power source disposed in said wearable frame, said rechargeable power source is wirelessly connectable to a wireless charger; and
a storage container for storing said wearable frame, wherein said storage container includes a wireless charger to charge said rechargeable power source while in storage wherein said audiovisual input assembly comprises a camera to receive visual input.
